(19) United States
(12) Patent Application Publication
(10) Pub. No.: US 2004/0232698 A1
(43) Pub. Date: Nov. 25, 2004

(54) Self restraining gasket and pipe joint

(76) Inventor: Jim Jones, Waco, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 10/440,809

(22) Filed: May 19, 2003

(51) Int. Cl. F16L 17/00; F16L 19/06; F16L 19/08

(52) U.S. Cl. 285/339

(57) ABSTRACT

A restraining element for preventing separation of a pipe joint used to join a bell end of a female plastic pipe to the male end of a mating pipe. The restraining element is formed from a compressible body of elastomeric material, the compressible body having a segmented metal ring located therein with gripping teeth for engaging an outer surface of the mating male pipe. The ring segments making up the segmented metal ring are oriented such that the gripping teeth of the ring segments are initially angled away from the outer surface of the male plastic pipe, the teeth of the annular gasket being forced into engagement with the exterior surface of the male plastic pipe as the pipe joint is assembled. The teeth are oriented to allow movement of the male pipe in a first direction relative to the female bell end opening but to resist movement in a opposite direction.

### BACKGROUND OF THE INVENTION

A. Field of the Invention

The present invention relates generally to the field of pipe connections and to devices used in the pipeline construction industry. More particularly, this invention relates to devices used to join the ends of plastic pipe in which a self-restraining pressure gasket is employed.

B. Description of the Prior Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, vitrified clay, and most recently, plastic including the various polyolefins and PVC.

In many applications where pipes are joined in telescoping relationship, the spigot end of one pipe is inserted into the socket end of the engaging pipe. The socket end has an opening large enough to receive the spigot end of the mating pipe. Often times, the materials being transported are fluid or gaseous in nature, and, particularly in those circumstances, it is desired that the pipeline be impervious to leaks. In order to accomplish that goal, and to achieve other objectives which will be herein described, those skilled in the business of pipe and pipeline construction are constantly in search of improved means for securing the joints formed by connecting the ends of pipe together. There are numerous methods currently in use by those in the pipe and pipeline construction industry to obtain a secure joint. These methods employ different types of components and also can be distinguished by the various ways in which such components are employed. The selection of these different methods will usually depend on the overall design requirements of the pipeline. In any event, a gasket is typically present within the socket end of the pipe which is intended to prevent leakage of fluid from the joint by forming a seal between the two pipe sections. This method is commonly used in plastic pipelines.

In addition to the necessity of providing an effective seal at the pipe joint, another important design requirement exists when it becomes necessary to join the pipe components in a restrained manner. This is usually desired in order to prevent the pipe components from separating due to thrust forces that often occur when the pipeline is subjected to internal pressure, and sometimes, when earth tremors or other external factors come into play.

In the case of iron pipelines, the devices for joining pipe have included the use of flanged fittings which are of appropriate diameter and which are fitted onto pipe ends in facing relationship to one another. In some cases, a gasket is employed between the faces of the flanged fittings to obtain a sealed joint. This is usually accomplished by bolting the flanged fittings together. In the case of iron pipe, set screws are sometimes inserted radially through the collar of the flange into the exterior surface of the pipe ends in order to secure the flanged fitting to the pipe ends.

A particularly preferred method of forming a sealed joint in the iron pipe industry utilizing a sealing “gland” is sometimes referred to as a “mechanical joint” or simply as an “MJ”. The bell end of an iron pipe section has a flanged portion cast on it. The spigot end of a second iron pipe is fitted with a slidable gland fitting and a gasket that is conically shaped such that one face of the gasket is diametrically larger than the second face of the gasket. The conically shaped gasket is positioned between the gland fitting and the spigot end of the pipe with the smaller, second face of the gasket being closer to the spigot end than the larger, first face of the gasket. The gland fitting has a plurality of apertures for receiving standard bolts. The joint is formed when the spigot is axially inserted into the bell, and the gland fitting and the flanged portion are bolted together, causing the lip of the gland fitting to compress the gasket thus sealing the two pipe pieces.

No exact counterpart to the iron pipe mechanical joint (MJ) presently exists in the marketplace for plastic pipe, however. Nevertheless, it is a generally required practice during installation of plastic pipelines, in, for example, municipal installations, that the pipe joints be restrained to accommodate varying pressures. There are various types of connections which are commercially available and which are used in the waterworks industry for restraining plastic pipelines. Each of these traditional restraining mechanisms adds considerable cost to the pipe installation as well as adding the possibility of human error depending on the specific conditions and applications. Most current restraining systems for plastic pipe systems offered in the industry require a substantial amount of labor to install. Under most installation conditions, the restraining systems are cumbersome to install and represent a substantial additional effort for the contractor.

U.S. Pat. No. 6,488,319, issued Dec. 3, 2002, to Jones, shows a method and apparatus for restraining plastic pipe against internal forces at a connection and to join and seal at least two pipes to form a pipeline where the pipes in question are plastic pipes as opposed to iron pipes. A self-restrained pressure gasket is utilized as a part of the design. The gasket has a continuous rigid ring formed as an integral part of the gasket. The rigid ring which forms the restraining mechanism has rows of teeth of varying lengths that, when assembled, engage at various points around the circumference of a mating pipe. The teeth adjust to the tolerances allowed in pipe manufacturing without losing gripping capacity.

Although the Jones patent represented an advance in the art, it was not intended to represent a mechanical joint for plastic pipe in the same way that the MJ designs have been used in the industry for iron pipe in the past. In other words, the female pipe end in the Jones patent was a typical belled plastic pipe end. There was no sealing gland fitting in the sense of the traditional MJ design, etc.

Accordingly, a needs continues to exist for an improved self restrained gasket and sealing system for a plastic pipeline which offers the advantages of a mechanical joint type sealing system.

A need also exists for such a system which is cost-effective, easy to manufacture and easy to use in the field and which is extremely dependable in operation.

A need also exists for such a system which effectively restrains plastic pipe against internal and external forces at a pipe or fitting connection and which effectively joins and seals at least two pipes to form a pipeline.

### SUMMARY OF THE INVENTION

The self-restrained pressure gasket of the invention is intended to be inserted within an annular groove provided in a bell end opening of a female plastic pipe and is capable of both joining and sealing the female plastic pipe to a mating male plastic pipe having an interior surface and an exterior surface. The gasket is formed with an annular gasket body made of a resilient elastomeric material and has an inner circumferential region and an outer circumferential region. A segmented ring formed of a plurality of hardened ring segments is integrally molded within the material of the gasket body so that the ring segments are at least partially embedded within the resilient elastomeric material. Each of the ring segments has an inner circumferential surface, an outer circumferential surface, front and rear end faces and opposing sides. At least one row of teeth is located on the inner circumferential surface of at least selected ones of the ring segments for engaging selected points on the exterior surface of the mating male plastic pipe. The ring segments are located within the annular gasket body with the inner circumferential surfaces thereof forming an acute angle with respect to the inner circumferential region of the gasket and with respect to the exterior surface of the mating male pipe section.

Preferably, a plurality of rows of teeth are located on the inner circumferential surface of at least selected ones of the ring segments. The acute angle which is formed between the inner circumferential surface of the ring segments and the inner circumferential region of the gasket is in the range from about 5 to 20 degrees. In a preferred embodiment of the invention, two parallel rows of teeth are located on the inner circumferential surface of at least selected ones of the ring segments, at least one of the rows of teeth being initially exposed from the resilient elastomeric material of the gasket body.

The self-restrained gasket of the invention can be used to form a pipe joint including a female plastic pipe having a bell end opening with an annual groove for receiving a sealing gasket. The bell end opening is sized to receive the male spigot end of a mating plastic pipe. The self-restrained pressure gasket is located within the annular groove provided in the bell end opening of the female plastic pipe. The mating plastic pipe is inserted into the bell end opening of the female plastic pipe with the male and female pipes being aligned along a central axis with at least selected teeth of the hardened ring segments being initially angled away from the outer surface of the male plastic pipe. The teeth of the annular gasket are forced into engagement with the exterior surface of the male plastic pipe as the pipe joint is assembled by means of a force applied to the rear end face of the ring segments. The teeth are oriented to allow movement of the male pipe in a first direction relative to the female bell end opening but to resist movement in a opposite direction.

Additional objects, features and advantages will be apparent in the written description which follows.

### BRIEF DESCRIPTION OF THE DRAWINGS

FIG. 1 is a horizontal, quarter sectional view of a pipe joint of the invention, the joint being shown in exploded fashion for ease of illustration.

FIG. 2 is again a horizontal sectional view of the pipe joint of the invention, with the joint being shown in the assembled condition.

FIG. 3 is an isolated, cross sectional view of one of the hardened metal ring segments used in the self-restraining gasket of the present invention.

FIG. 4 is another horizontal, quarter sectional view of the pipe joint of the invention showing the assembly of the gland fitting which is used to make up the joint.

FIG. 5 is a quarter sectional plan view of the layout of the gripping elements in the self-restraining gasket of the invention.

### DETAILED DESCRIPTION OF THE INVENTION

It is well known in the art to extrude plastic pipes in an elongated cylindrical configuration of a desired diameter and to then cut the extruded product into individual lengths of convenient size suitable for handling, shipping and installing. By “plastic” is meant a section of pipe formed from a convenient polyolefin or polyolefin derivitive such as polypropylene, polyethylene or polyvinylchloride (PVC). The preferred plastic material for purposes of the present invention is PVC. Each length of pipe is enlarged or “belled” at one end sufficiently to join the next adjacent pipe section by receiving in the belled end the unenlarged or “spigot” end of the next adjacent length of pipe within the bell end opening. The inside diameter of the bell is formed sufficiently large to receive the spigot end of the next section of pipe with sufficient clearance to allow the application of an elastomeric gasket or other sealing device designed to prevent leakage at pipe joints when a plurality of pipe lengths are joined to form a pipeline.

Plastic pipes of the above type have, for many years, been joined by utilizing an elastomeric gasket which is compressed between the inside walls of the bell and the outside wall of the plain or beveled end of the spigot end of the next pipe in a series of telescoped pipes. The gasket is typically retained within a groove provided in the bell end opening of the female pipe section. One problem which exists, however, is finding a way to “restrain” the assembled pipe joint so that the joint will not separate due to internal or external pressure, or due to environmental factors such as earth movement.

As mentioned in the background discussion of the invention, the iron pipe industry has addressed the problem of providing a restrained pipe joint by utilizing a sealing “gland” and fitting, sometimes referred to as a “mechanical joint” or simply as an “MJ”. The bell end of an iron pipe section has a flanged portion cast on it. The spigot end of a second iron pipe is fitted with a slidable gland fitting and a gasket that is conically shaped. The conically shaped gasket is positioned between the gland fitting and the spigot end of the pipe. The gland fitting has a plurality of apertures for receiving standard bolts. The joint is formed when the spigot is axially inserted into the bell, and the gland fitting and the flanged portion are bolted together, causing the lip of the gland fitting to compress the gasket thus sealing the two sections of pipe.

One object of the present invention is to provide an improved self-restraining gasket which can be used in a variety of sealing situation. In other words, the gasket of the invention might be used in a standard plastic pipe joint to join a belled pipe end to a mating plain end male pipe. Alternatively, the gasket of the invention might be used as the sealing element in a “fitting” which is used to make up a joint between two plain end pipe sections. In a particularly preferred form of the invention, the gasket of the invention is used to make up a mechanical joint of the type previously available only in cast iron pipe joints.

Because of the different materials of plastic pipe systems and cast iron pipe systems, the sealing components utilized must be designed differently. The restraining mechanism employed will differ in the plastic pipe system, primarily due to the fact that the plastic pipe can be “scored” or crushed by the restraining mechanism if improper stresses are exerted during the joint assembly or during use. This is not generally a problem in the case of cast iron pipe, because of the difference in material making up the pipe itself.

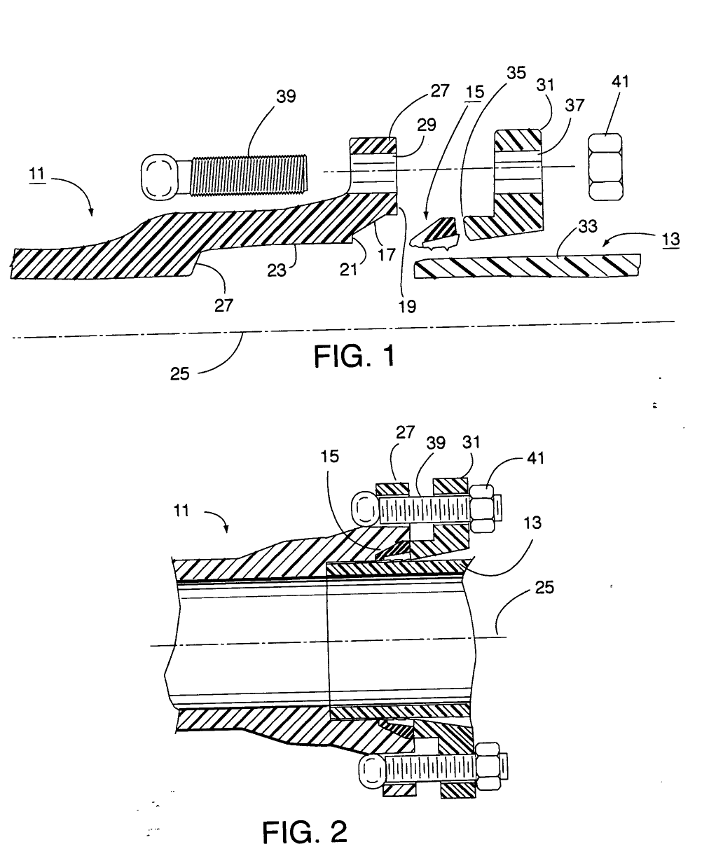

In the preferred embodiment illustrated in FIG. 1, there is shown a joint is to be formed between a pipe bell end 11 of one pipe and plain spigot end 13 of a second pipe. The second pipe 13 is to be inserted into the belled end 11 of the enclosing pipe. The gasket 15 of the present invention is shown in exploded fashion with the other components of the pipe joint in FIG. 1.

The inner surface of the pipe bell end 11 has a retainer groove 17 for retaining the gasket 15. The groove 17 is bounded by a front wall 19 and by a retainer wall 21. In addition, the bell pipe end has a throat region 23 which extends longitudinally inwardly parallel to the pipe axis 25 and joins a shoulder region 27. The bell pipe end 11 also has a flanged collar region 27 which includes a plurality of apertures 29. A circumferential gland fitting 31 is sized to be received about an outer surface 33 of the mating male plastic pipe 13. The gland fitting 33 has a forward lip region 35 which contacts and compresses the body of the gasket 15 as the joint is assembled (see FIG. 2). The gland fitting 31 also has a plurality of apertures 37 which are arranged to be aligned with the apertures in the flange collar region 27 of the bell end. A bolting means such as bolts 39 and nuts 41 are used to join the apertures of the bell pipe end and the gland fitting as shown in FIG. 2.

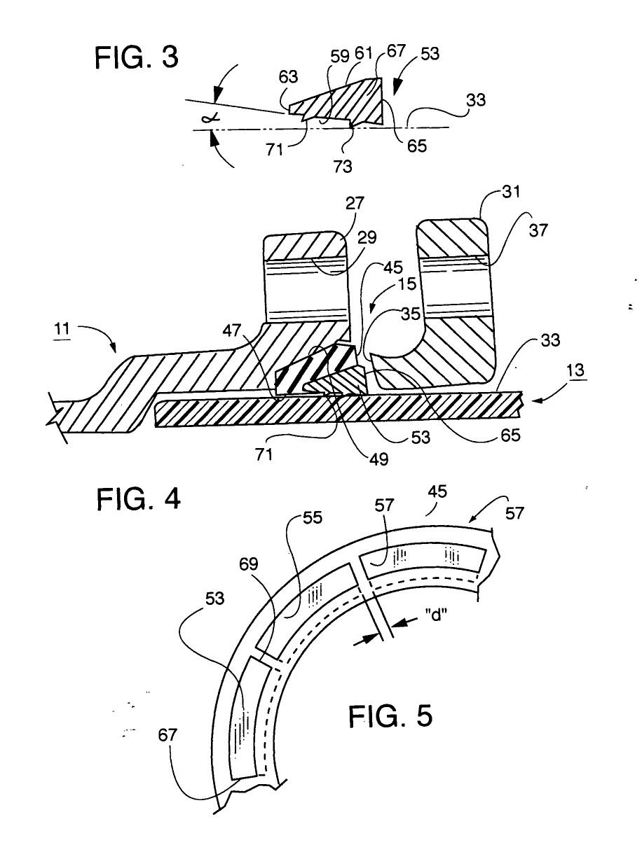

As shown in FIGS. 3-5, the self-restrained pressure gasket 15 includes an annular gasket body 45 made of a resilient elastomeric material, such as a suitable natural or synthetic rubber. The annular gasket body 45 has an inner circumferential region 47 and an outer circumferential region 49. The gasket body 45 is generally cone shaped, as view in cross section in FIG. 4.

A segmented ring (51 in FIG. 5) formed of a plurality of hardened ring segments is present within the gasket body. Preferably, the segmented ring 51 is integrally molded within the material of the gasket body 45 so that the ring segments are at least partially embedded within the resilient elastomeric material. Each of the ring segments, is shown in FIG. 3, has an inner circumferential surface 59, and outer circumferential surface 61, front and rear end faces 63, 65 and opposing sides 67, 69. At least one row of teeth 71 are located on the inner circumferential surface 59 of at least selected ones of the ring segments 53 for engaging selected points on the exterior surface 33 of the mating male plastic pipe 13. In the preferred embodiment illustrated in FIG. 3, the ring segments 53 have two parallel rows 71, 73 of teeth located on the inner circumferential surface 59 of at least selected ones of the ring segments. Preferably, each of the ring segments is provided with two parallel rows of teeth. The rows of teeth 71, 73 may be completely encapsulated within the elastomeric material of the gasket 45 or may be partially exposed therefrom. As shown in FIG. 4, the rear end face 65 of the segment 53 protrudes slightly from the resilient elastomeric material 35 of the gasket body in the embodiment illustrated

As illustrated in FIG. 3, the ring segments 53 are located within the annular gasket body with the inner circumferential region surface 59 thereof forming an acute angle α with respect to the inner circumferential region 59 of the gasket and with respect to the exterior surface 33 of the mating male pipe section (illustrated by phantom lines in FIG. 3). In the preferred embodiment illustrated, the acute angle α which is formed between the inner circumferential surface 59 of the ring segment 53 and the inner circumferential region 47 of the gasket is in the range from about 5° o 20°, most preferably about 7° to 10°.

Because of the orientation of the ring segments 53 within the gasket body, the rows of teeth 71, 73 do not engage the pipe exterior surface 33 until the joint is assembled. In other words, some compression of the gasket is necessary before the teeth 71, 73 are forced downwardly in the direction of the pipe exterior 33. With reference to FIG. 4, as the gland fitting 31 is moved in the direction of the flange collar region 27 of the bell pipe end, the lip region 35 of the gland fitting contacts the rear end face 65 of the segment 53 causing the teeth 71, 73 to be rotated downwardly in the direction of the pipe exterior surface 33. This action causes the rows of teeth 71, 73 to actually protrude through the rubber of the gasket body 45 and bite into the exterior surface of the mating male pipe section 33.

As illustrated in FIG. 5, the riing segments (53, 55, 57, illustrated) completely circumscribe the gasket with only a slight gap or distance (illustrated as “d” in FIG. 5) between the segments. This distance is not critical, but is generally as small a gap as is necessary to accommodate installation of the gasket about the mating male pipe section. Some distance between the segments is generally necessary because the gasket body must be stretched slightly in order to fit about the male pipe end. As the joint is assembled and the gland fitting is moved into position, however, the segments move closer together so that the distance “d” decreases, resulting in a nearly complete 360° circumferential contact about the pipe exterior 33.

An invention has been provided with several advantages. The self-restrained pressure gasket of the invention is capable of joining and sealing the female bell pipe end of a plastic pipe to a mating male spigot end of a second plastic pipe. Because the ring segments are integrally molded within the annular gasket body, the possibility of mistakes during field assembly are virtually eliminated. Because the ring segments are integral part of the gasket body, as internal pressure builds, the ring segment supply more pressure to the exterior surface of the mating male spigot pipe end. This action helps to insure the integrity of the joint. Additionally, the hardened ring segments aid in sealing the joint by keeping a constant gripping pressure at even the lowest operating pressure of the pipeline.

The teeth provided on the inner circumferential region of the ring segments are oriented to allow movement of the male spigot end in a first longitudinal direction relative to the female belled end but to resist movement in a opposite longitudinal direction once the joint is assembled. Where the self-restrained pressure gasket is used as a part of a mechanical joint, a self-restrained joint is provided for plastic pipe which equals or exceeds the self-restraining and sealing capabilities of the prior art cast iron pipe systems.

While the invention has been shown in one of its forms, it is not thus limited but is susceptible to various changes and modifications without departing from the spirit thereof.

I claim:

1. A self-restrained pressure gasket for insertion within an annular groove provided in a bell end opening of a female plastic pipe capable of both joining and sealing the female plastic pipe to a mating male plastic pipe having an interior surface and an exterior surface, the gasket comprising:
an annular gasket body made of a resilient elastomeric material, the annular gasket body having an inner circumferential region and an outer circumferential region;
a segmented ring formed of a plurality of hardened ring segments integrally molded within the material of the gasket body so that the ring segments are at least partially embedded within the resilient elastomeric material, each of the ring segments having an inner circumferential surface, an outer circumferential surface, front and rear end faces and opposing sides;
at least one row of teeth located on the inner circumferential surface of at least selected ones of the ring segments for engaging selected points on the exterior surface of the mating male plastic pipe;
wherein the ring segments are located within the annular gasket body with the inner circumferential surfaces thereof forming an acute angle with respect to the inner circumferential region of the gasket and with respect to the exterior surface of the mating male plastic pipe.

2. The self-restrained pressure gasket of claim 1, wherein a plurality of rows of teeth are located on the inner circumferential surface of at least selected ones of the ring segments.

3. The self-restrained pressure gasket of claim 1 wherein the acute angle which is formed between the inner circumferential surface of the ring segments and the inner circumferential region of the gasket is in the range from about 5 to 20 degrees.

4. The self-restrained pressure gasket of claim 1 wherein the plastic pipe is made of PVC.

5. The self-restrained pressure gasket of claim 1, wherein the end faces of the ring segments protrude slightly from the resilient elastomeric material of the gasket body.

6. The self-restrained pressure gasket of claim 1, wherein two parallel rows of teeth are located on the inner circumferential surface of at least selected ones of the ring segments, at least one of the rows of teeth being initially exposed from the resilient elastomeric material of the gasket body.

7. A pipe joint comprising:
a female plastic pipe having a bell end opening with an annual groove for receiving a sealing gasket, the bell end opening being sized to receive the male spigot end of a mating plastic pipe having an interior surface and an exterior surface;
a self-restrained pressure gasket located within the annular groove provided in the bell end opening of the female plastic pipe capable of both joining and sealing the female plastic pipe to the male plastic pipe, the gasket comprising:
an annular gasket body made of a resilient elastomeric material, the annular gasket body having an inner circumferential region and an outer circumferential region;
a segmented ring formed of a plurality of hardened ring segments integrally molded within the material of the gasket body so that the ring segments are at least partially embedded within the resilient elastomeric material, each of the ring segments having an inner circumferential surface, an outer circumferential surface, front and rear end faces and opposing sides;
at least one row of teeth located on the inner circumferential surface of at least selected ones of the ring segments for engaging selected points on the exterior surface of the mating male plastic pipe;
wherein the ring segments are located within the annular gasket body with the inner circumferential surfaces thereof forming an acute angle with respect to the inner circumferential region of the gasket and with respect to the exterior surface of the mating male plastic pipe.

8. The pipe joint of claim 7, wherein a plurality of rows of teeth are located on the inner circumferential surface of at least selected ones of the ring segments.

9. The pipe joint of claim 7, wherein the acute angle which is formed between the inner circumferential surface of the ring segments and the inner circumferential region of the gasket is in the range from about 5 to 20 degrees.

10. The pipe joint of claim 7, wherein the plastic pipe is made of PVC.

11. The pipe joint of claim 7, wherein the end faces of the ring segments protrude slightly from the resilient elastomeric material of the gasket body.

12. The pipe joint of claim 7, wherein two parallel rows of teeth are located on the inner circumferential surface of at least selected ones of the ring segments, at least one of the rows of teeth being initially exposed from the resilient elastomeric material of the gasket body.

11. Method of joining and sealing a female plastic pipe to a mating male plastic pipe having an outer pipe surface, the method comprising the steps of:
providing an annular gasket having an annular gasket body made of a resilient elastomeric material, the annular gasket body having an inner circumferential region and an outer circumferential region, the gasket body also having a segmented ring formed of a plurality of hardened ring segments integrally molded within the material of the gasket body so that the ring segments are at least partially embedded within the resilient elastomeric material, each of the ring segments having an inner circumferential surface, an outer circumferential surface, front and rear end faces and opposing sides;
wherein at least one row of teeth is located on the inner circumferential surface of at least selected ones of the ring segments for engaging selected points on the exterior surface of the mating male plastic pipe;
wherein the ring segments are located within the annular gasket body with the inner circumferential surfaces thereof forming an acute angle with respect to the inner circumferential region of the gasket;
inserting the gasket body into an annular grove provided within a bell end opening of the female plastic pipe;
inserting the mating male plastic pipe into the bell end opening of the female plastic pipe with the male and female pipes being aligned along a central axis with at least selected teeth of the hardened ring segments being initially angled away from the outer surface of the male plastic pipe, the teeth of the annular gasket being forced into engagement with the exterior surface of the male plastic pipe as the pipe joint is assembled, the teeth being oriented to allow movement of the male pipe in a first direction relative to the female bell end opening but to resist movement in a opposite direction.

12. The method of claim 11, wherein a plurality of rows of teeth are located on the inner circumferential surface of at least selected ones of the ring segments.

13. The method of claim 11, wherein the acute angle which is formed between the teeth of the ring segments and the outer surface of the plastic pipe is in the range from about 5 to 20 degrees.

14. The method of claim 11, wherein the ring segments have opposing front and rear end faces and wherein the rear end faces of the ring segments protrude slightly from the resilient elastomeric material of the gasket body.

15. The method of claim 11, wherein two parallel rows of teeth are located on the inner circumferential surface of at least selected ones of the ring segments, at least one of the rows of teeth being initially exposed from the resilient elastomeric material of the gasket body.

16. A pipe joint, comprising:
a female plastic pipe having a bell end opening with an annual groove for receiving a sealing gasket, the bell end opening being sized to receive the male spigot end of a mating plastic pipe, the bell end opening also forming a flanged collar region;
a self-restrained pressure gasket located within the annular groove provided in the bell end opening of the female plastic pipe capable of both joining and sealing the female plastic pipe to the male plastic pipe, the gasket comprising:
an annular gasket body made of a resilient elastomeric material, the annular gasket body having an inner circumferential region and an outer circumferential region;
a segmented ring formed of a plurality of hardened ring segments integrally molded within the material of the gasket body so that the ring segments are at least partially embedded within the resilient elastomeric material, each of the ring segments having an inner circumferential surface, an outer circumferential surface, front and rear end faces and opposing sides;
at least one row of teeth located on the inner circumferential surface of at least selected ones of the ring segments for engaging selected points on the exterior surface of the mating male plastic pipe;
wherein the ring segments are located within the annular gasket body with the inner circumferential surfaces thereof forming an acute angle with respect to the inner circumferential region of the gasket;
a circumferential gland fitting sized to be received about the outer surface of the mating male plastic pipe, the gland fitting having a forward lip region which contacts and compresses the gasket body as the joint is assembled.

17. The pipe joint of claim 16, wherein the flanged collar region of the bell pipe end and the gland fitting each have a plurality of apertures therein, the apertures of the gland fitting being aligned with apertures of the flanged collar region.

18. The pipe joint of claim 17, further comprising a bolting means which joins the apertures of the bell pipe end and the gland fitting.

19. The pipe joint of claim 18, wherein the bolting means is made up of nuts and bolts.
